(19) United States
(12) Patent Application Publication
(10) Pub. No.: US 2014/0122166 A1
(43) Pub. Date: May 1, 2014

(54) CROWDSOURCED BEHAVIOR MODIFICATION

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/665,908

(22) Filed: Oct. 31, 2012

(51) Int. Cl. G06Q 30/02

(52) U.S. Cl. CPC G06Q 30/0201
USPC 705/7.29

(57) ABSTRACT

Systems and methods are disclosed for providing crowdsourced contest for a behavior modification plan such as a plan to modify a user's diet, spending habits, or meals. A contest definition may be formulated based on a request received from the user and an analysis of the user's purchase history. The contest may be published to potential respondents based on analysis of the respondent's own purchase history. Payments may be authorized upon selection of a respondent's plan. The user's purchasing activity may be monitored and reported to the selected respondent to facilitate coaching. Coaching activity may be facilitated and or detected and payment authorized for such activity. Achievement of goals may be verified using the purchase activity of the user and payment authorized to the selected respondent to the extent goals are achieved.

### BACKGROUND

1. Field of the Invention

This invention relates to systems and methods for facilitating crowdsourced ideas to achieve personal goals.

2. Background of the Invention

In recent years crowdsourcing has evolved as a way to harness the “wisdom of a crowd” in order to arrive at solutions to problems. In a typical crowdsourcing scenario, a problem is posed to the general public and a reward may be pledged for the best solution. After a given time period, a winning solution may be selected and the reward transferred to the submitter of the winning solution. Alternatively, a crowdsourced problem may be published and responses received with no promise of compensation. In another approach, a crowdsourced problem may be posed and responses aggregated in order to provide a corpus of knowledge on a subject or issue.

The systems and methods disclosed herein provide novel approaches to soliciting crowdsourced solutions to achieve lifestyle modification for individuals.

### BRIEF DESCRIPTION OF THE DRAWINGS

In order that the advantages of the invention will be readily understood, a more particular description of the invention will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram

FIG. 2 is a block diagram of a computing device suitable for implementing embodiments of the present invention;

FIG. 3 is a process flow diagram of a method for generating a crowdsourced contest in accordance with an embodiment of the present invention;

FIG. 4 is a process flow diagram of a method for running a crowdsourced contest in accordance with an embodiment of the present invention;

FIG. 5 is a process flow diagram of a method for generating a crowdsourced meal planning contest in accordance with an embodiment of the present invention;

FIG. 6 is a process flow diagram of a method for managing a crowdsourced meal planning contest in accordance with an embodiment of the present invention;

FIG. 7 is process flow diagram of a method for generating a crowdsourced diet modification contest in accordance with an embodiment of the present invention;

FIG. 8 is a process flow diagram of a method for managing a crowdsourced diet modification contest in accordance with an embodiment of the present invention;

FIG. 9 is a process flow diagram of a method for generating a crowdsourced budget modification contest in accordance with an embodiment of the present invention; and

FIG. 10 is a process flow diagram of a method for managing a crowdsourced budget modification contest in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

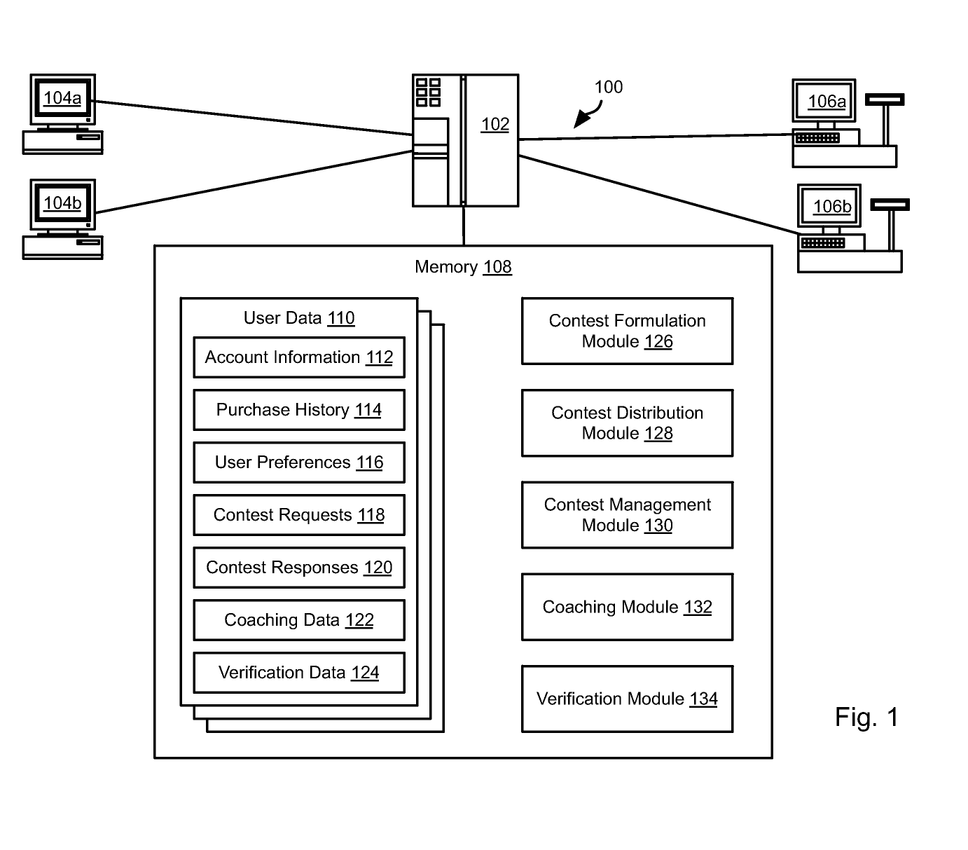

FIG. 1 illustrates a system 100 in which methods described hereinbelow may be implemented. The system 100 may include a server system 102 that may be embodied as one or more server systems each including one or more processors that are in data communication with one another. The server system 102 may be in data communication with one or more user computers 104a, 104b and one or more point of sale (POS) devices 106a, 106b. For purposes of this disclosure, discussion of communication with a user or activity by the user may be interpreted as communication with a computer 104a, 104b associated with the user or activity taking place on a computer associated with the user. The POS 106a, 106b may be located within a store. In some embodiments, a POS 106a, 106b may be operable to process online transactions. In some embodiments, separate computers of the server system 102 may handle communication with the user computers 104a, 104b and POS 106a, 106b.

The server 102 may be in data communication with a memory 108. The memory 108 may include one or more non-transitory data storage devices and/or one or more transitory data storage devices. In particular, the memory 108 may include random access memory (RAM) for operational use of the server system 102, one or more hard drives hard drive or other local persistent storage for facilitating performance of methods disclosed herein, and one or more databases for storing large data sets.

The memory 108 may store user data 110 for users that perform one or both of interacting with the server 102 by means of a user computer 104a, 104b and purchasing items at a POS 106a, 106b. The user data 110 may include account information 112 such as a username, password, identification information, demographic information, or the like. The account information 112 may include information gathered from the user based on interaction with the user or provided expressly by the user when setting up or editing a profile.

The user data 110 may also include a purchase history 114. In some embodiments, a user may request or otherwise sign up to receive or access electronic receipts that represent an authoritative record of transactions of the user at a POS 106a, 106b.

For purpose of this disclosure and in the various embodiments disclosed herein, a purchase history may include all purchases on a receipt associated with a user. Likewise, for purposes of this disclosure and the various embodiments disclosed herein a purchase history may include a subset of all purchases associated with a user or user account. For example, at any point in the methods described herein where a purchase history is evaluated, a subset of all purchases as identified by the user may be used instead. For example, in a family, one person may do most the shopping but all items purchased are not for the same person. Accordingly, a member of the family that is participating in the methods described herein may self-select from all purchases, those items that were for that member of the family or that member consumed. In some embodiments, a user may indicate a fraction of an item that was consumed by the user. In some embodiments, an interface may be provide on a user computing device 104a-104b to permit a user to select this subset and communicate it to the server for user or storage in accordance with the methods described herein. The receipts may include, or be representable as, an image of the paper receipt that user received or would typically receive in a conventional POS transaction.

In some embodiments, user data 110 may include user preferences 116. As described in greater detail hereinbelow, a user's input regarding a taste profile or other preference or practice may be solicited and/or received and stored as user preferences 116 for purposes of generating and managing crowdsourced contests in accordance with methods described herein.

The user data 110 may further include data regarding crowdsourced contests that the user has requested or for which the user has submitted a response. Accordingly, the user data 110 may include contests requests 118 generated at a user's request, responses 120 to contests requested by other users, coaching data 122 (described in detail below), and verification data 124. Verification data 124 may include data for verifying adoption of a plan proposed as a response to a contest or achievement of goals specified in a contest request.

The memory 108 may additionally store executable data for performing methods as described in greater detail hereinbelow. In particular, the memory 108 may include a contest formulation module 126, contest distribution module 128, contest management module 130, coaching module 132, and a verification module 134.

A contest formulation module 126 analyzes one or more of the purchase history 114, user preferences 116, and any explicit parameters of a request for a contest received from a user. The contest formulation module 126 uses this information to automatically define a contest definition for publication to a crowdsourcing forum or community.

The contest distribution module 128 publishes a contest definition to one or more potential respondents. The content distribution module 128 may publish a contest definition by emailing the contest to potential respondents, associating the contest definition with accounts of potential respondents on a crowdsourcing website or interface, posting on a publically available site or forum, posting on a social media site, or any other means of distribution. In some embodiments, the contest distribution module 128 analyzes user data 110 of potential respondents and selects a subset of potential respondents that have similar tastes, preferences, or other attributes as a user that has requested a contest, as reflected by the user data 110 of the user.

The coaching module 132 performs one or both of facilitating and monitoring coaching of a user by a respondent whose behavior modification proposal was accepted by the user. The coaching module 132 may provide a forum for communication between the user and respondent, monitor communication between the user and respondent, and provide data on behavior of the user to the respondent for purposes of providing coaching. For example, where the contest is for a budgeting plan, the purchasing history of the user, or a report based thereon, may be provided to the respondent to enable the respondent to provide meaningful feedback.

The verification module 134 may monitor the purchase history 114 of a user in order to determine whether any one of the following has occurred: a response to the contest that has been selected has in fact been adopted, a goal specified in the contest has been met, and progress has been made toward the goal. The methods that may be performed by the verification module 134 and the other modules described above are described in greater detail below.

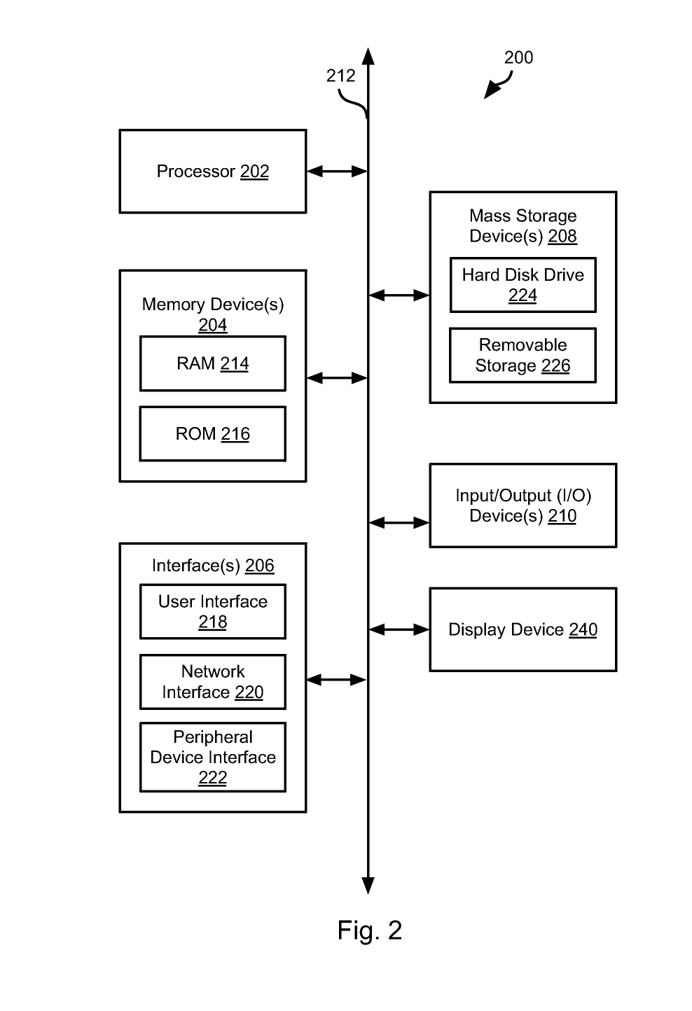

FIG. 2 is a block diagram illustrating an example computing device 200. Computing device 200 may be used to perform various procedures, such as those discussed herein. A server system 102, user computer 104a, 104b, and POS 106, 106b may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

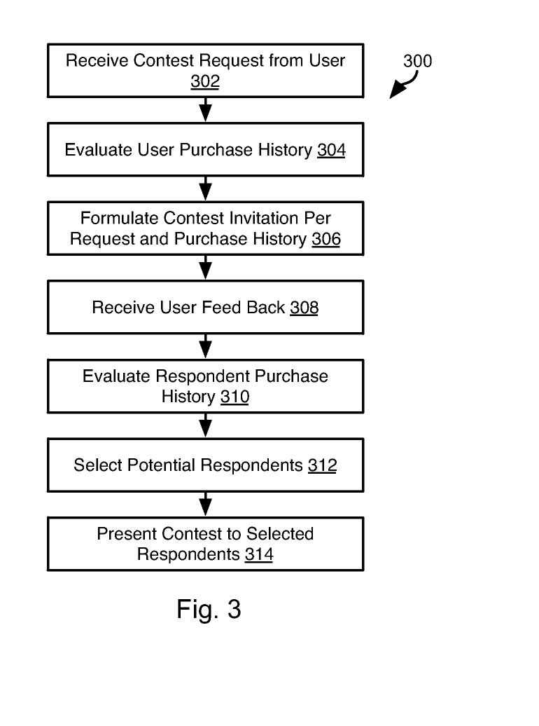

FIG. 3 illustrates a method 300 for generating a definition of a crowdsourced contest in accordance with embodiments of the present invention. The methods disclosed herein find particular application in crowdsourced contests to help users achieve changes in behavior or lifestyle or perform any type of self-improvement. However, some or all of the methods described herein may be used in other crowdsourced contexts.

The method 300 may include receiving 302 a request for a contest from a user, evaluating 304 one or both of a user's purchase history and preferences, and formulating 306 a contest definition according to the request received from the user and the evaluation 304 of the user's purchase history and/or preferences. Receiving 302 a contest definition may also include receiving authorization of payment, confirmation of payment, payment information, or some other manifestation of payment by the user for providing compensation to one or both of the entity providing the crowdsourcing forum and the respondent that is selected as the winner of the contest. For purposes of this disclosure, authorization of payment to respondents may be viewed as the authorization of payment from funds provided by the user sponsoring the contest. For purposes of this disclosure payments that are authorized or made may include actual monetary payments, points, credits that may be used within the crowd sourcing forum for other purposes (such as sponsoring other contests), any other item of intrinsic or sentimental value, or any other recognition of a contribution that can be associated with a user in the crowd sourcing forum or any other social or financial context.

Receiving 302 the request for a contest may include a textual description of a lifestyle change the user would like to accomplish. In some embodiment, a form may be provided that is used to define parameters for a specific type of lifestyle change. Accordingly, a part of the request may include selection of a specific type of lifestyle change and parameters input into a form or as responses to queries corresponding to the selected lifestyle change. A request may also specify a reward for one or more of submitting a response that is selected by the user, providing coaching, successful achievement of a goal by the user, or other events. In some embodiments, a standard prize for some or all of these events may be specified by a crowdsourcing forum such that a price need not be specified by the user.

Evaluating 304 one or both of the user's purchase history and preferences may include characterizing a current state of the user with respect to a goal of the user specified in the request. For example, information that can be gathered from a purchase history includes expenses, dietary habits, food tastes, media preferences, game console ownership, and the like. The type of information that may be gathered from the purchase history may include any data that can be inferred from the types of items purchased and the frequency or time at which they are purchased. Any method known in the art for inferring a user's tastes, attributes, or interests known in the art of analyzing user behavior may be used to analyze the user's purchase history and infer information therefrom.

Formulating 306 a contest definition may include using the request received from the user and information inferred from the user to formulate a definition for a contest. For example, where the contest is to modify an aspect of a user's lifestyle, the current state of that aspect of the user's lifestyle may be inferred from the user's purchase history and included in the purchase history. Likewise, where a request specifies a goal in relative terms, the amount of improvement or change may be calculated according to the current state of the aspect of the user's lifestyle as inferred from the user's purchase history and/or preferences. In some embodiments, the contest definition as formulated 306 may be presented to the user and the user may provide feedback. The feedback may be received 308 and the contest definition modified in accordance with the feedback.

In some embodiments, rather than publish contest definitions to all potential respondents and risk respondents frustration from too many contest requests, a contest definition may be published or promoted to a subset of potential respondents. Accordingly, the method 300 may include evaluating 310 purchase histories of a pool of potential respondents. Other reference information such as self reported attributes, interests, or expertise of respondents may also be evaluated 310. In some embodiments, prior submissions of responses in other contests and prior selections of the respondent as a winner of contests may also be evaluated 310. The relationship between some or all of these reference data may be compared to one or both of the subject matter of the contest definition and the purchase history and preferences of the user. A subset of the potential respondents may be selected 312. For example, the top N potential respondents with the most closely related reference data may be selected as related potential respondents.

The contest definition may then be presented 314 to the selected potential respondents. Presentation 314 may include publication on a website, emailing, posting on a social media site, associating with an account or inbox of the selected respondents in a crowdsourcing forum, or the like. In some embodiments, contest definitions may be returned as search results to potential respondents who seek out possible contests in a crowdsourcing forum or website. A contest definition may be selected from among a plurality of contest definitions for returning as a search result based on a relationship of one or more of the user purchase history, user preferences, contest request, and contest definition, to a query input by a potential respondent.

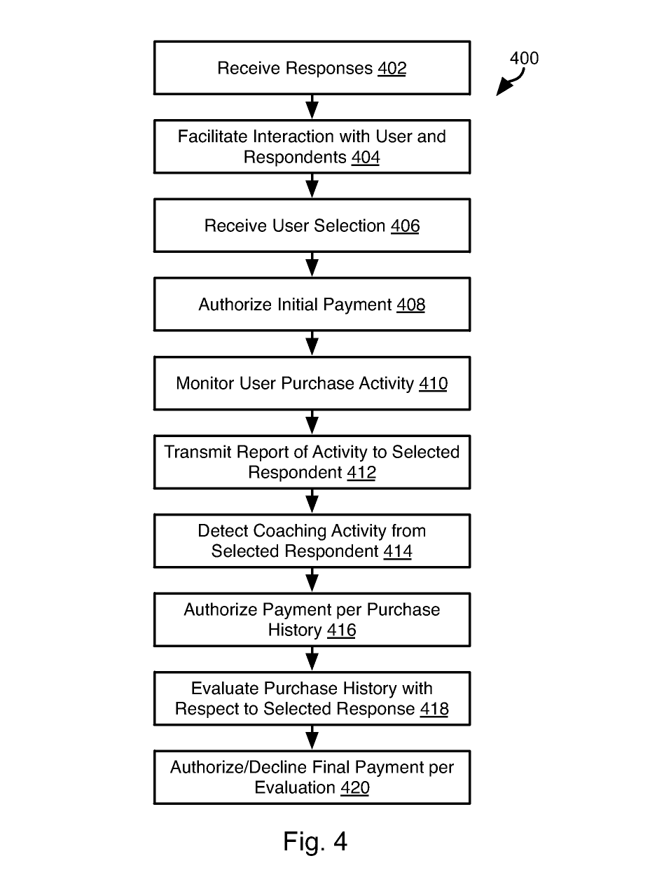

FIG. 4 illustrates a method 400 for managing a crowdsourcing contest, such as a crowdsourcing contest as defined and distributed using the method 300. The method 400 may include receiving 402 responses to a published contest definition and presenting some or all of the responses to the user. A response may include a description of a solution or a plan for achieving a lifestyle change specified in the contest definition. In some embodiments, a response may additionally or alternatively include a description of the qualifications or experience of the respondent.

In some embodiments, responses received 402 or identifiers of respondents may be presented to the user and communication between the user and respondents may be facilitated 404. Interaction may enable the user to request clarification regarding a proposed plan or a respondents qualifications or experiences. Interaction may be facilitated by providing contact information of the respondent for any type of electronic communication to the user. Interaction may also be facilitated by providing a dedicated voice or text communication system on a crowdsourcing forum that is operable to receive some or all of voice, video, or text data from one user computer 104a and transmit it to a second user computer 104b.

A user selection of one of the responses received may then be received 406 from the user, such as from a user computer 104a, 104b associated from the user. This may include receiving a user click on an interface element representing a response on a web page or other interface presenting representations of the responses or respondents. Where the contest is structured to provide payment upon selection, an initial payment may be authorized 408 to the respondent who submitted the selected response upon or after the user selects the response. The initial payment may be deemed owed to the selected respondent upon selection but may payment may be actually authorized and performed at anytime after selection by the user, including after occurrence of any of the steps of the method 400.

In some embodiments, a selected respondent may also provide coaching including additional guidance, feedback on behavior after the selection of a response, encouragement, and the like. In such embodiments, the method 400 may include some or all of steps 410-414. For example, the method 400 may include monitoring 410 user purchase activity subsequent to selection of a selected response. In some embodiments, a user may also keep a log of progress that may likewise be stored or monitored as part of the method 400. Information obtained from monitoring 410 may be transmitted 412 to the selected respondent. Information may be transmitted on a daily, weekly, or some other periodic basis. Information may be transmitted to the selected respondent when requested by the selected respondent.

The selected respondent may provide coaching to the user in the form of text messages, emails, voice messages, video conferencing, and the like. In some embodiments, some or all of this activity may take place through communication channels provided in a crowdsourcing forum such that it can be detected 414. In some embodiments, payment may be authorized 416 for coaching activity that is detected. The amount of the payment may be any value and may vary based on one or more of the type of the interaction (e.g. text, voice, or video chat), the duration of the interaction, and the frequency of the interaction. User feedback on the value of the coaching activity may also be used to compute an amount of payment for coaching activity.

In some embodiments, a selected respondent may be compensated to the extent a user adopts a solution proposed by the selected respondent or achieves goals specified in a contest definition or request for a contest. In some embodiments, accomplishment of a goal may be self reported by the user and reported to an entity running a crowdsourcing forum. The entity may then authorize payment to the selected respondent.

In the illustrated embodiment, the method 400 includes evaluating 418 a purchase history of the user at some time or some interval subsequent to selection of the selected response by the user. Evaluating 418 the subsequent activity may include evaluating an aspect of the user's lifestyle that was the subject of the contest and is reflected in the user's purchase history. If the evaluation 418 indicates complete or partial achievement of a goal, then payment to the selected respondent may be authorized 420. In some embodiments, the amount authorized 420 for payment may be proportional or otherwise correspond to the progress of the user toward achievement of the goal.

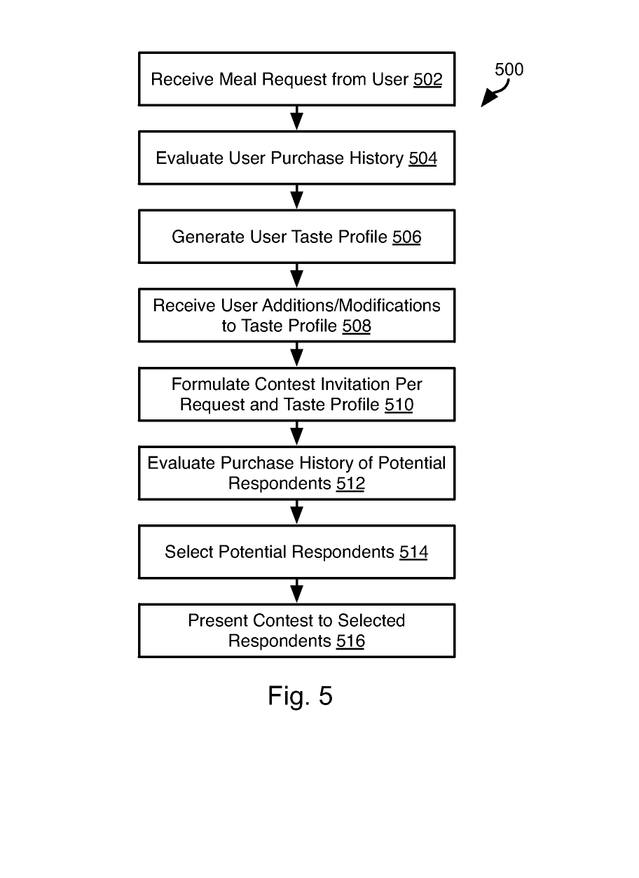

As noted above, the methods disclosed herein may be applied to various lifestyle changes that a user may wish to make. For example, FIG. 5 illustrates a method 500 for generating a contest for a meal plan in accordance with an embodiment of the present invention. The method may include receiving 502 a request for a meal plan. The request may include such information as a number of family members, ages of family members, food allergies or other dietary restrictions, type of food (Mexican, Italian, Chinese, etc.), and the like. As for the method 500, the purchase history of the user may also be evaluated 504 and a taste profile generated 506 according to the evaluation. Evaluating 504 the purchase history may include evaluating ingredients or products that are purchased to identify attributes of food the user apparently prefers. For example, ingredients corresponding to a particular type of food that are purchased in combination or with high frequency may indicate a preference for that type of food. In some embodiments, the evaluation 504 may identify dietary restrictions from the absence of certain common items. The method 500 may further include requesting and/or receiving 508 any additions or modifications to the user's taste profile. In some embodiments, the user specified tastes and preferences may be part of a user profile that exists before the meal request is received 502.

The method 500 may include formulating 510 a contest invitation according to the request received 502 and the taste profile of the user. The contest invitation may include some or all of the taste profile of the user as well as any restrictions or requirements specified in the request.

In some embodiments, a pool of potential respondents may be evaluated 512. In particular, one or both of a purchase history and self declared taste profile of the pool of potential respondents may be evaluated 512 to identify correspondence between the tastes of the potential respondents and the tastes of the user. The top N potential respondents with the highest taste correspondence with the user may be selected 514. Alternatively or additionally, those potential respondents with a threshold taste similarity with respect to the user may be selected 514. The contest may then be presented 516 to the selected 516 as described hereinabove with respect to the method 400.

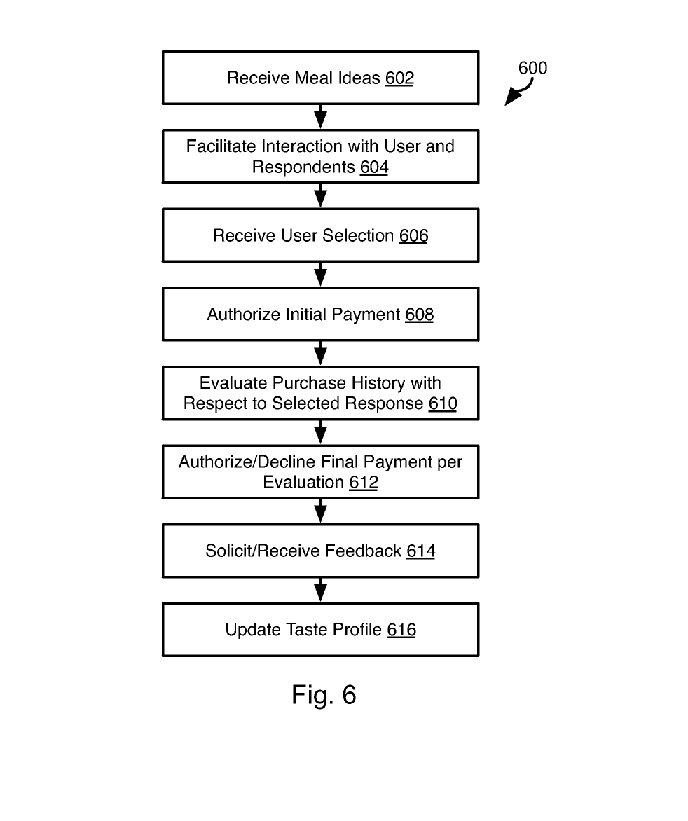

FIG. 6 illustrates an example method 600 for managing a crowdsourced contest for a meal plan. The method 600 may include receiving 602 meal ideas and presenting all or part of them to the user. The meal ideas 602 may be received 602 in the same manner as responses received in the method 400 described above. In the example of a contest for a meal plan, the meal ideas received 602 may include some or all of recipes, combinations of recipes, cookbooks, store names, cooking supplies, cooking tools, and a statement of a responder's qualifications as a chef. Likewise, interaction between potential respondents may be facilitated 604 and a user selection received 606 in a similar manner as for the method 400. As for the method 400, an initial payment may be authorized 608 upon selection by the user of a response. In some embodiments, information may be withheld from a response in order to prevent a user from exploiting the meal plan without selecting it and compensating the responder. For example, in a recipe, quantities may be redacted or certain key ingredients omitted.

In some embodiments, a purchase history of the user subsequent to receiving the selected 606 response or selecting 606 the selected response may be evaluated 610. The purchase history may be evaluated 610 with respect to the selected meal plan. In particular, the ingredients and grouping of ingredients in the transactions evaluated may be compared to meal plans to detect possible shopping for the recipes and other parts of the selected 606 meal plan. In some embodiments, a payment may also be authorized 612 upon verifying that the user has in fact adopted some or all of the selected meal plan.

The method 600 may additionally include soliciting and/or receiving 614 feedback from the user regarding the meal plan. This may include, for example, input from the user liking or disliking a recipe or proposing modifications to the recipes. The feedback received 614 may then be used to update 616 the taste profile of the users. This may include, for example, adding new types of food or ingredients corresponding to recipes of the selected response.

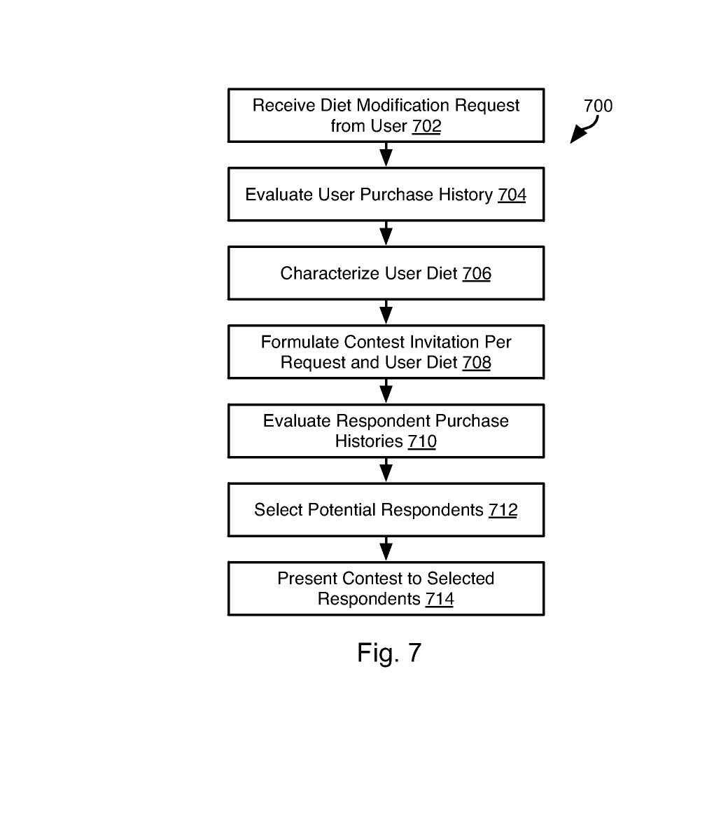

FIG. 7 illustrates an alternative method 700 for using crowdsourced lifestyle modification plans in accordance with an embodiment of the present invention. In particular, the illustrated method 700 may be used to generate a crowdsourced contest for a diet modification plan. In particular, a diet modification plan may include a plan to eat a healthier diet, to lose weight, to eat a diet adhering more closely to a dietary philosophy (e.g. vegan, vegetarian, Atkins diet, kosher, Halal, or the like), or some other diet modification. Accordingly, the method 700 may include receiving 702 a request for a diet modification plan from a user in the manner as described above with respect to the method 400.

As for the method 400, the user's purchase history may be evaluated 704. In the context of the method 700, evaluating 704 the user's purchase history may include evaluating 704 compliance of the user's diet with respect to the dietary goals specified in the request. The evaluation 704 may be used to characterize 706 a user's diet to establish a baseline to measure improvement of the user with respect to the goal. For example, where the goal is to lose weight or reduce calories, the caloric value of the user's purchases on a weekly basis (or some other interval) may be computed to characterize 706 the user's current diet.

A contest may then be formulated 708 in accordance with one or both of the request and the characterization of the user's diet. For example, formulating 708 a goal may include based on the current state of the user's diet, reducing the caloric value to an achievable level. In some embodiments, a recommended reduction may be automatically generated as part of the formulation 708.

As for the other methods disclosure herein, the formulated 708 contest may be published to a pool of candidate respondents. This may include evaluating 710 respondent purchase histories, selecting 712 potential respondents, and presenting 714 the contest to the selected respondents as in other embodiments disclosure herein. In some embodiments, rather than selecting 712 potential respondents that have a diet (as inferred from the purchase history of the respondent) that is most similar to the user, potential respondents may be selected 712 according to a similarity of the inferred diet of the potential respondents to the goal of the user. That is to say, a respondent that has achieved the goal that the user is seeking may be rated more highly as a potential respondent.

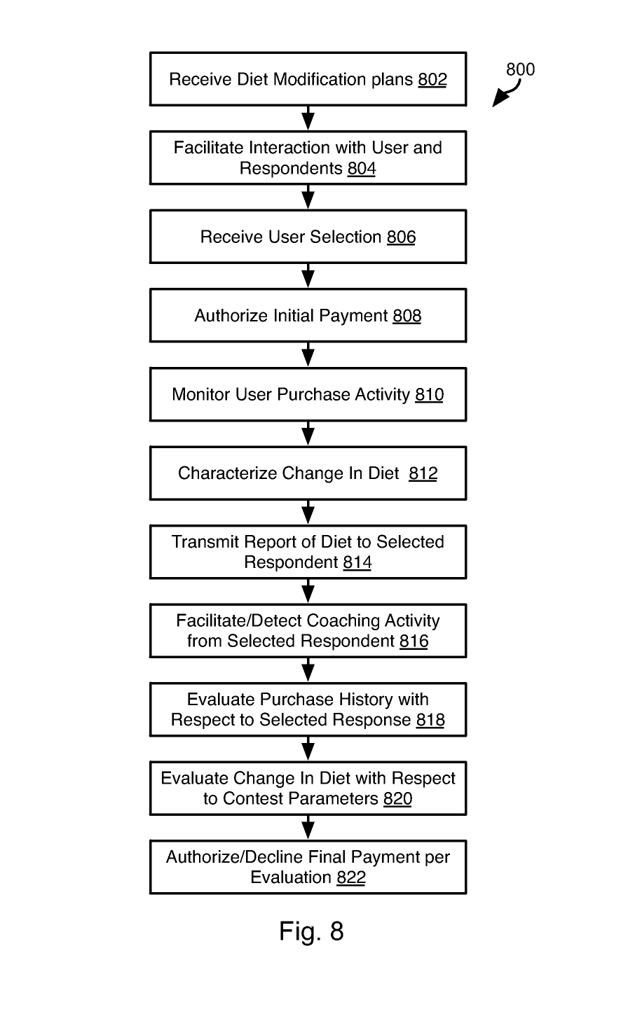

FIG. 8 illustrates a method 800 for managing a crowdsourced contest for a diet modification plan. As for the other methods disclosed herein, a number of diet modification plans from a plurality of respondents may be received 802 and interaction between the user and one or more of the respondents may be facilitated as desired by the user. For a diet modification plan, the content of the plan may include any advice or substitution that a user might wish. For example, a respondent may be presented with a report of ingredients for foods purchase by a user and propose an adequate substitution or an alternative method of preparation. As for other embodiments, a respondent may simply describe the respondent's expertise or qualifications rather than a plan at this phase. Additionally or alternatively, some of part of the plan may be withheld until the user makes a selection of a response including the plan. Upon receiving 806 a user selection of a response, a payment may be authorized 808 to the respondent who submitted the selected response. The full details of the selected response may be disclosed to the user if all or part thereof was withheld.

As for the other embodiments disclosed herein, the user's purchase activity subsequent to one of submitting the request and selecting the selected response may be monitored 810 and any change in the user's diet characterized 812. A report of the change in diet may be transmitted 814 to the selected respondent on a periodic basis or as requested by the selected respondent. Coaching activity of the selected respondent for the user may then be one or both of facilitated and detected 816. As for other embodiments disclosed herein, payment to the selected respondent may be authorized in accordance with the detected 816 coaching activity in the manner described above.

In some embodiments, the purchase history of the user subsequent to selection of the response may be evaluated 818 and any change of the user's diet reflected in the purchase history may also be evaluated 820. Payment to the selected respondent may then be authorized 822 if the dietary goal specified in the contest has been reached or to an extent the user has progressed toward the dietary goal.

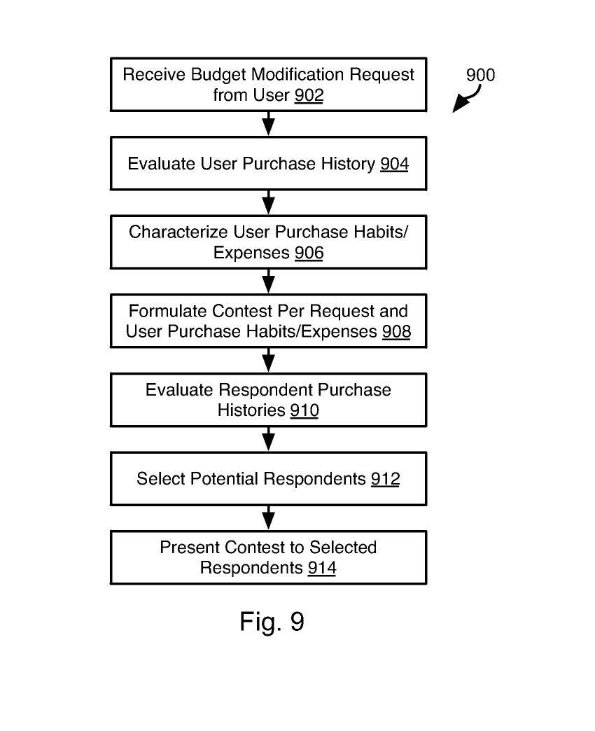

FIG. 9 illustrates a method 900 for generating a crowdsourced contest for a budget plan or other plan to save a user money in accordance with an embodiment of the present invention. The method 900 may include receiving 902 a request for a budget modification plan from a user. The request may be received in the same manner as other embodiments disclosed herein. A budget modification request may be as simple as an amount of money a user wishes to save each month. Or a general request to find a way to save as much money as possible. The user's purchase history may be evaluated 904 and used to characterize a user's purchasing habits and/or expenses. For example, the amount of money the user spends on a number of classes of items (food, produce, cosmetics, cleaning supplies, etc.) may be extracted from the purchase history. In some embodiments, the user may also report other expenses and income that are not reflected in the purchase history.

A contest may be formulated 908 according to one or both of the request and the characterization of the user's expenses and spending habits. For example, the request may include a report of what the user purchases on a monthly or weekly basis, or some other interval.

As for other embodiments, the contest may be published or presented to potential respondents. The pool of potential respondents may be selected 912 to include respondents that have similar spending habits as the user as determined according to an evaluation 910 of the purchase histories of the potential respondents. In some embodiments, potential respondents may be selected according to a similarity of spending habits of the potential respondents to a goal of the user. In some embodiments, rather than spending habits commonality of the potential respondents with the user may be used to selected potential respondents, such as a number of children, geographic location, income, and the like. The contest as formulated may then be presented 914 to one or more potential respondents, such as the selected 912 respondents in the same manner as the other embodiments disclosed herein.

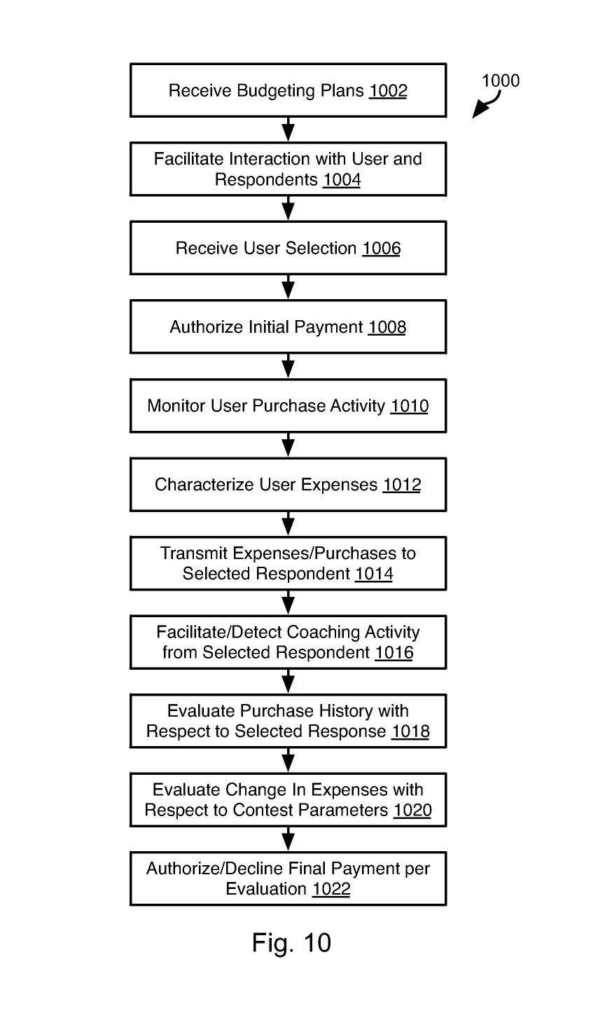

FIG. 10 illustrates a method 1000 for managing a crowdsourced contest for a budget plan. The method 1000 may include receiving 1002 proposed budget plans from a plurality of respondents in the same manner as in other embodiments disclosed herein. A budget plan may include any ideas to save the user money. For example, a budget plan may include proposed substitutions for items the user commonly buys, an alternative brand of item, coupons that may be available, ways to eliminate the need for certain items or use less of them, and the like. In some embodiments, budget plans may be presented to the user for selection. In order to maintain the integrity of the contest, the user may be presented with a bottom line figure of money saved with a plan rather than details of the plan. Alternatively or additionally the user may be provided with the qualifications or experience of the respondent submitting a plan or a portion of a plan to enable the user to select a plan. As for other embodiments, communication between the user and one or more respondents may be facilitated 1004 in the same manner as for the other embodiments.

A user selection of a budget plan may be received 1006 and an initial payment to the selected respondent that submitted the selected plan may be authorized 1008 in the same manner as in other embodiments disclosed herein. In the method 1000 an amount of payment to the selected respondent may correspond to the amount of money the respondents plan or coaching achieve for the user. Accordingly, authorizing 1008 a payment before any savings have been verified may be omitted or used to offset other payments that might otherwise be due in order to achieve payments that reflect savings of the user.

As for other embodiments, the selected respondent may have an opportunity and incentive to provide coaching to the user. Accordingly, the users purchasing activity subsequent to one or both of submitting a request for a contest and selected a budget plan may be monitored 1010 and used to characterize 1012 the user's expenses. Some or all of the user's purchase history, a characterization of the user's expenses, and a report based thereon may be transmitted 1014 to the selected respondent, either at some interval or at the request of the selected respondent.

Coaching activity of the selected respondent for the user may be facilitated and/or detected 1016 in the same manner as in other embodiments disclosed herein. Payments to the selected respondent may also be authorized for the detected coaching activity.

As noted above, in some embodiments, payments authorized for the selected respondent may be in proportion to the money saved by the user. Accordingly, at an end of a contest interval or periodically at some interval, the method 1000 may include evaluating 1018 purchasing activity of the user within the interval and evaluating 1020 any change in the user's expenses. A payment to the selected respondent may then be authorized or declined 1022 in view of the evaluation. For example, payment to the selected respondent may be authorized for a percentage of the savings or according to some fixed amount. Alternatively, the amount of the payment authorized may be in proportion or otherwise determined according to how close the user came to a goal specified in the request for a contest, the contest definition, or in the selected response.

The present invention may be embodied in other specific forms with000hout departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A crowdsourcing method comprising:
receiving, by a computer system, a contest request from a user;
analyzing, by the computer system, a purchase history of the user and generating a contest definition according to the contest request and the purchase history; and
publishing, by the computer system, the contest definition to a crowdsourcing community.

2. The method of claim 1, wherein publishing the contest definition to a crowdsourcing community further comprises:
evaluating purchase histories of a plurality of candidates with respect to the purchase history of the user;
selecting a set of candidates from the plurality of candidates according to the evaluation; and
publishing the contest definition to the set of candidates.

3. The method of claim 1, further comprising, receiving feedback from the user regarding the contest definition and modifying the contest definition according to the feedback.

4. The method of claim 1, wherein analyzing the purchase history of the user comprises analyzing transaction information received from in-store points of sale.

5. The method of claim 4, wherein analyzing transaction information received from an in-store points of sale further comprises analyzing a subset of items selected from the transaction information by a user.

6. The method of claim 4, wherein the transaction information is associated with the user according to self-identification of the user at the in store points of sale.

7. The method of claim 4, wherein the transaction information is electronic receipt information accessible by the user.

8. The method of claim 1, further comprising:
receiving at least one response from at least one respondent to the contest definition; and
receiving a user selection of selected response received from a selected respondent from the at least one respondent.

9. The method of claim 8, further comprising:
monitoring subsequent purchasing of the user subsequent to receiving selection of the selected respondent; and
determining whether the subsequent purchasing indicates adoption of the selected response.

10. The method of claim 9, further comprising, authorizing payment to the selected respondent if the subsequent purchasing indicates adoption of the selected response.

11. The method of claim 8, further comprising authorizing payment to the selected respondent upon selection of the selected response by the user.

12. The method of claim 8, further comprising:
monitoring subsequent purchasing of the user;
transmitting a report of the subsequent purchasing to the selected respondent; and
detecting coaching activity of the selected respondent to the user.

13. The method of claim 12, further comprising, authorizing payment to the selected respondent upon detecting coaching activity.

14. The method of claim 8, wherein:
the contest request is a request for a meal plan; and
wherein analyzing the purchase history of the user includes detecting food preferences of the user.

15. The system of claim 14, wherein publishing the contest definition to a crowdsourcing community further comprises:
evaluating purchase histories of a plurality of candidates with respect to the purchase history of the user to identify food preferences of the plurality of candidates;
selecting a set of candidates from the plurality of candidates according to a similarity of the food preferences of the plurality of candidates to the food preferences of the user; and
publishing the contest definition to the set of candidates.

16. The method of claim 15, wherein the selected response is a meal plan, the method further comprising:
receiving user feedback on the meal plan; and
updating the user's food preferences according to the feedback.

17. The method of claim 1, wherein:
the request is a request for a diet plan; and
wherein analyzing the purchase history of the user comprises determining dietary habits of the user according to the purchase history.

18. The method of claim 1, wherein:
the request is a request for a budgeting plan; and
wherein analyzing the purchase history of the user comprises determining spending habits of the user according to the purchase history.

19. A system for crowdsourcing comprising one or more processors and one or more memory devices operably coupled to the one or more processors, the one or more memory devices storing executable and operational data effective to cause the one or more processors to:
receive a contest request from a user;
analyze a purchase history of the user and generating a contest definition according to the contest request and the purchase history; and
publish the contest definition to a crowdsourcing community.

20. The system of claim 19, wherein the executable and operational code are further effective to publish the contest definition to a crowdsourcing community by:
evaluating purchase histories of a plurality of candidates with respect to the purchase history of the user;
selecting a set of candidates from the plurality of candidates according to the evaluation; and
publishing the contest definition to the set of candidates.

21. The system of claim 19, wherein the executable and operational code are further effective to receive feedback from the user regarding the contest definition and modify the contest definition according to the feedback.
